(19) United States
(12) Patent Application Publication
(10) Pub. No.: US 2010/0049678 A1
(43) Pub. Date: Feb. 25, 2010

(54) SYSTEM AND METHOD OF PREFETCHING AND CACHING WEB SERVICES REQUESTS

(75) Inventors: Ming Huang, Ottawa (CA); Babak Esfandiari, Ottawa (CA); Shikharesh Majumdar, Ottawa (CA)

Correspondence Address: Kramer & Amado, P.C., 1725 Duke Street, Suite 240, Alexandria, VA, 22314, US

(73) Assignee: Alcatel-Lucent, Paris (FR)

(21) Appl. No.: 12/197,608

(22) Filed: Aug. 25, 2008

(51) Int. Cl. G06N 5/02; G06N 5/04

(52) U.S. Cl. 706/14; 706/47

(57) ABSTRACT

A web services request prefetching proxy receives web services registry requests from a client, applies a prediction rule to the request to generate likely next web services registry requests, searches the web services registry based on the predicted likely next web services requests, and preloads a caching proxy with a search result. The caching proxy receives web services registry requests and, depending on a hit or miss, reports to the client.

### TECHNICAL FIELD

Embodiments relate generally to web services, including searching and accessing registries that list published web services.

### BACKGROUND

Providers of web-accessible applications and other web services publish descriptions of their applications and services in registries, which are searchable by entities such as, for example existing and potential business clients.

A prime objective of the web services registry is to provide a useable, practical catalog of service providers and their associated services, with enough information to enable clients with a defined need to search, and hopefully find, particular service providers and specific web services that best meets those needs.

Further to this end, standards for the structure of the registries, as well as for the descriptions published by the service providers have been developed and are being widely adopted. The web service registry standards, in general, specify structural templates to represent information about service providers, the nature of their services, and mechanisms to access them. The most widely adopted, but not the only, registry standard is the Universal Description, Discovery and Integration (UDDI), which is an eXtensible Markup Language (XML) specification, conforming to the XML Web Services Definition Language (WSDL). Details of UDDI are well published and readily accessible to persons of skill in the web service registry and related arts. Another registry standard, although much less adopted but potentially alternative or supplemental to UDDI, is the OASIS ebXML Registry, which is based on the Electronic Business using eXtensible Markup Language (ebXML). Details of OASIS are also widely published and accessible to persons of skill in the related arts.

A goal of UDDI and alternative standards such as, for example, the ebXML registry, is through platform-independent protocols, semantics and classifications, to obtain a practical and efficient means for thousand of businesses and other service providers to publish their many and varied services, in a catalog manner readily searchable and accessible by potential clients, preferably using standardized search systems.

Various problems have arisen, though, that are not conducive to meeting certain goals of web service registries.

One example is latency, meaning the round trip time between a client sending a request to the web service registry and the time the client receives the response. Many factors bear on the latency, some arising from networking issues not particular to UDDI, some arising from general XML processing overhead, and some arising from the complexity of various search algorithms employed in searching a UDDI registry.

Another example problem, having various overlap with the latency issue, is network overhead, as measured at various nodes throughout the interconnections between the clients and the web services registry.

### SUMMARY

The present invention and various exemplary embodiments and aspects provide, among other benefits, improved latency in comparison to related art web service registry search and access systems.

The present invention and various exemplary embodiments and aspects further provide at least one or more of the benefits of reduced network load, reduced web service registry load and reduced cost in comparison to related art web service registry search and access systems.

In summary, one or more embodiments provide any one or more of the above-identified and other benefits by an arrangement having a web service request caching proxy to receive web services requests from clients, the caching proxy connected via a web service request prefetching proxy to a web service registry.

According to one or embodiments, the web service request prefetching proxy maintains, based on a history of received web service search requests, a likely next web service request prediction rule or process, and applies the rule or process to received web service requests to prefetch web service results from the web service registry, and preloads the web service request caching proxy with the prefetched results, prior to receiving a subsequent request, providing significant cache hit rate and various benefits including, but not limited to, one or more of reduced latency, reduced network load, and reduced web service registry load.

According to one or more aspects of one or more embodiments, the web service request prefetching proxy maintains a service request prediction rule or process, and applies the rule or process to received web service requests to generate a plurality of likely next web service requests, the plurality meeting a given likelihood or probability threshold, and prefetches web service results from the web service registry for each of the plurality, and preloads the web service request caching proxy with the prefetched results prior to receiving a subsequent request, providing benefits including, but not limited to, even higher cache hit rates and further associated benefits.

### BRIEF DESCRIPTION OF THE DRAWINGS

FIG. 1 illustrates an example system having an architecture according to various embodiments;

FIG. 2 is a functional block diagram of one illustrative example web services request caching proxy of a system according to various embodiments;

FIG. 3 is a sequence diagram of an illustrative example execution using a caching proxy and prefetching proxy preload of the caching proxy according to various embodiments;

FIG. 4 is a graphical description of one illustrative example of a directed graph rule for a prefetching and cache pre-load according to various embodiments;

FIG. 5 is a graphical representation of example aspects of generating a directed graph rule for a prefetching and cache pre-load according to various embodiments; and

FIG. 6 is a process flow chart representation of various aspects of generating a directed rule for a prefetching and cache pre-load according to various embodiments.

### DESCRIPTION

The following describes exemplary embodiments to a detail that clearly enables a person of skill in the relevant art to practice the invention according to its best mode contemplated by the present inventors.

However, as will be apparent to persons skilled in the relevant arts upon reading this disclosure, the particular examples are illustrative, and various embodiments may be practiced according to and within various alternative arrangements and implementations, which are readily identified by such persons, but that depart from the specific depicted illustrative examples.

To avoid obscuring novel features and aspects, the following description omits various details of methods and techniques known to persons skilled in the relevant arts which, based on this disclosure, such persons will employ to practice according to the embodiments.

Various embodiments and exemplary features may be described separately but, although these may have various differences, are not necessarily mutually exclusive. For example, a particular feature, function, action or characteristic described in relation to one embodiment may be included in other embodiments.

In the drawings, like numerals and appearing in different drawings, either of the same or different embodiments of the invention, reference functional blocks or system blocks that are, or may be, identical or substantially identical between the different drawings.

Various aspects, functions and operations may be graphically depicted or described as one block, or as an arrangement of blocks but, unless otherwise stated or made clear from the context, the particular number and arrangement of blocks is only a graphical, logical representation not a limitation on implementations for practicing the embodiments.

The term “engine,” as used herein, means any data processing machine capable of accepting an input and processing the input and/or performing operations based on the input, to generate an output in accordance with the function recited for the engine.

Illustrative examples of “data processing machine” include, but are not limited to, a general purpose programmable computer or resource having one or more processor cores, or distributed resource of processor cores, connected to storage media storing machine-readable instructions that, when executed by the processor cores, effect a state machine, and/or perform other operations to carry out the function recited for the engine.

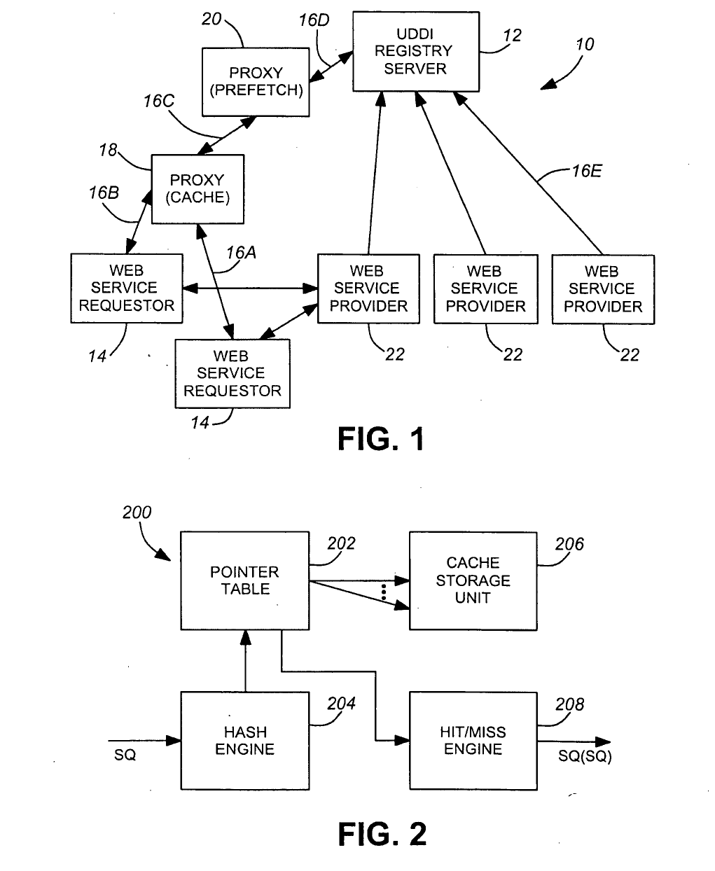

FIG. 1 illustrates one example of one system architecture 10 in accordance with various embodiments.

Referring to FIG. 1, the example architecture 10 is described according to various example engines, which is only one illustrative arrangement in terms of example engines, for purposes of describing various exemplary embodiment, and is are not a limitation of alternative and equivalent embodiments.

Further, it will be understood, by persons of ordinary skill in the art, upon reading this description, that the illustrative arrangement of engines may, or may not be representative of various hardware and/or hardware/software arrangements by which a person of ordinary skill in the art, based on the present disclosure, may implement and practice according to the embodiments.

Referring now to FIG. 1, one example architecture 10 is depicted, showing exemplary embodiments of the invention, and providing environments for practicing various exemplary embodiments. It will be apparent to persons skilled in the relevant arts that the architecture 10 is a functional representation, and not necessarily proportional to or otherwise representing the relative physical location and spacing of particular hardware implementing the various functions and engines.

The example 10 includes Web Services registry 12 which may or may not be a UDDI registry, populated, as one illustrative example, with UDDI or equivalent structure of cataloged information about, for example businesses and other service providers, the services that they offer and communication standards and interfaces they use to conduct transactions. As will be apparent to persons skilled in the relevant arts upon reading this disclosure, specific examples of service providers and of web services provided are not relevant to understanding the various embodiments and aspects and, therefore, are omitted.

With continuing reference to FIG. 1, web services registry 12 may be implemented on, for example, any of the various commercially available web registry environments that are known to persons skilled in the relevant arts such as, for example, the IBM Websphere™, the BEA Weblogic™ or the Microsoft Enterprise™ UDDI system. These are only arbitrary, illustrative examples of environments, presented in an arbitrary order, without regard to any preference or suitability with respect to practicing the present invention. As will be apparent to persons skilled in the relevant arts, details of these commercially available web registry environments, to the extent required such persons to conform and combine these environments with the present disclosure to practice according to the present invention, are well-known and readily available to such persons and, therefore, are omitted.

Referring to FIG. 1, the example architecture 10 further includes at least one web services requester 14, connectable by path 16A to a web services search caching proxy 18 that may connect to the web services registry 12, and may, in accordance with various aspects, connect via path 16C to web services search prefetching proxy 20 which, in turn, is connectable via path 16D to the web services registry 12. The FIG.1 example architecture 10 may include at least one web services provider 22 having means (not separately labeled) for providing, or for enabling the providing of, services published in the web services registry 12 through, for example, a communication path 16E. Further, a connection path 16E may connect at least one web services provider 22 to the web services registry 12 for purposes of publishing the provider's services and related information.

Referring to FIG. 1, it will be apparent upon reading this disclosure that the structure and configuration of the web services requester 14 is not required to be particularized to practicing the present invention. The web services requester 14 may, for example, be any apparatus, method or system known in the relevant art that queries a web services registry such as 12. As one illustrative example, the web services requestor 14 may be embodied as, or within applications or software modules executable on any data processing machine (not separately shown in FIG. 1) that perform operations, with knowledge or without knowledge of or input from a human user, including queries of a UDDI or other web services registry such as registry 12. As will be apparent to persons skilled in the relevant arts, the data processing machine may be a conventional programmable computer (not shown in FIG. 1), a server or equivalent aspect of a thin-client or equivalent system. Further, the web services requestor 14 may be an aspect or software module of a web access capable personal digital assistant (PDA) device operating, for example, in combination with a web-based application (not shown in FIG. 1) such as, for example, travel planning and reservations services (not specifically shown in FIG. 1),

With respect to data processing apparatus and the executable instructions, as will be apparent to persons skilled in the relevant arts based on this disclosure, the web services requester 14 of the example architecture 10 may be implemented on, or may reside on, any of various commercially available web services systems and/or environments (not specifically shown in FIG. 1). Illustrative examples include, in no particular order: Business Explorer for Web Services™ (BE4WS) available from IBM, the UDDI Directory Explorer™ available from BEA, Inc., or lower scale systems such as, for example, the JAX View™ 4.0 available from Managed Methods, Inc., as well as any other alternative UDDI Search Markup Language (USML) or equivalent XML system capable of querying a UDDI or equivalent web services registry 12. These illustrative example environments for the web services requester 14 are only examples, presented in arbitrary order, representing no particular order of their suitability to the present invention.

As will be apparent to persons skilled in the relevant arts, details of commercially available web registry and access systems, to the extent, if any, such details are required for such persons to practice the present invention upon reading this disclosure, are well known and, further, are readily available to such persons. Therefore, such details are unnecessary and, thus are omitted to avoid obscuring the novel aspects of the invention.

Referring to FIG. 1, queries to the web registry 12 that are generated by the web services requester 14 are referenced generally as “search requests,” and are labeled, for purposes of reference, generally as SQ and individually as SQⱼ. It will be understood that “search requests” encompass any request communicated to the web services registry 12, directly or indirectly, from a web services requestor such as the web requestor 14 or equivalent, with or without human input or awareness of the request. Further, the search requests SQ may be in, or embody, any message format and may use any messaging protocol usable for accessing a web services registry, including, but not limited to, UDDI or ebXML.

As described above and as shown at FIG. 1, the web services requestor 14 of the example architecture 10 is connected by, for example, logical communication path 16A or equivalent, to the web services request caching proxy 18. Functionally, the web services search caching proxy 18 maintains a cache engine (not separately shown in FIG. 1) storing previous search requests SQ, along with the web registry 12 results corresponding to each, supplemented by a web search request prefetching using predicted or most likely values of a next search request, based on preceding search requests. As described in greater detail in sections below, according to one aspect, the rule for predicting next search requests, which are used for prefetching web services registry 12 content, is a rule-based estimator, constructed based on a recorded and, preferably, continually updated history of sequences of search requests SQ received from the search requestor 14. According to one aspect, the “search requestor” may comprise multiple individual search requesters, with search requests SQ from each contributing to the history on which the rule-based estimator is constructe.

With continuing reference to FIG. 1, the functions of generating the prediction rule for performing the prefetch, as well as performing the prefetch are represented in the FIG. 1 architecture as the web services search prefetching proxy 20, which is described in greater detail in sections hereinbelow.

FIG. 2 shows a functional block diagram of one illustrative example web services search caching proxy 200 according to which the search caching proxy 18 of a system according to the FIG. 1 example 10 may be implemented.

Referring now to FIG. 2, the example web services search caching proxy 200 may include a pointer table 202 or equivalent, e.g., a translation lookaside buffer, storing a hash H(SQ) generated by hash engine 204, of each of a quantity M of previously received search queries SQ. The example caching proxy may include a cache storage unit 206 storing the web services registry 12 search results WR(SQ) for each of these M search queries SQ, each search result WR(SQ) being retrievable using the hash H(SQ) of its corresponding search request SQ in the pointer table 202. The example next search cache 200 may include a HIT/MISS detection engine 208 that, upon receiving a search request SQ, inspects the pointer table 202, detects whether the pointer corresponding to the particular SQ is stored in that pointer table 202 and, based on the result, generates a HIT or a MISS data.

With continuing reference to FIG. 2, preferably the web services search caching proxy 200 includes a HIT report engine (not separately illustrated) that, in response to the HIT/MISS detection engine 208 detecting a HIT, accesses the cache storage unit 206, retrieves the corresponding stored web services registry result for the particular SQ, i.e., WR(SQ), and communicates this over, for example, the logical path 16A of FIG. 1 to the search requestor 14. The example web services search caching proxy 200 preferably includes a MISS report/update engine (not separately illustrated) that, in response to the HIT/MISS detecting engine 208 detecting a miss, communicates the particular search request SQ over, for example, the paths 16C and 16D to the web services registry 12, receives a result WSR(SQ), communicates the result WSR(SQ) to the requestor 14, updates the pointer table 202 to store the hash H(SQ) of that search request generated by the hash engine 204, and updates the cache storage unit 206 to store WR(SQ), pointed to by H(SQ) stored in the pointer table 202.

With continuing reference to FIG. 2, as readily apparent to persons skilled in the relevant arts based on this disclosure, the example web services search caching proxy 200, as well as various alternative embodiments of the web services request caching proxy 18, may be constructed and practiced according to the invention using, for example, known methods and techniques of content-addressable memory (CAM), and/or other associative memories, in combination with the present disclosure.

Referring to FIG. 1, the web services search prefetching proxy 20 generates, based on each search request SQⱼ forwarded to the proxy 20, a likely next search request E{SQⱼ₊₁|SQⱼ₊₁}=ESQⱼ₊₁. As described above, preferably a search request SQj is forwarded to the prefetching proxy only in the instances the caching proxy 18 identifies a MISS. It will be understood that ESQⱼ₊₁ may be a set, having a single member or a plurality of members. ESQⱼ₊₁ is generated by, for example, applying a rule, generically referenced herein as E, to SQⱼ. According to one aspect, generation of ESQⱼ₊₁ may be performed using a rule E that is calculated based on observed sequences of web services requests SQ and, according to one aspect, may be continually updated, as described in greater detail in later sections.

According to various exemplary embodiments, the web services search prefetching proxy 20 performs the prefetch and cache preload by communicating ESQⱼ₊₁ to the web services register 12, obtaining the search result WR(ESQⱼ₊₁), and updating the web services search caching proxy 18 accordingly.

As will be apparent to persons skilled in the relevant arts based on this disclosure, although described and depicted in FIG. 1 as separate, the web services search caching proxy and the web services search prefetching proxy 20 may, or may not be separate and may or may not reside in a common processing resource.

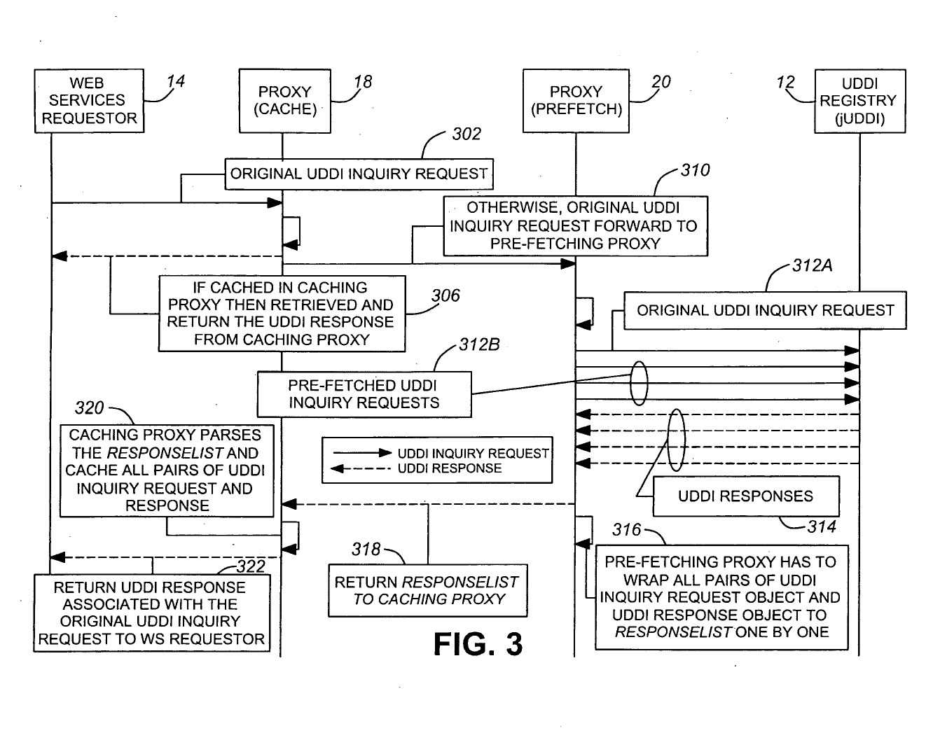

FIG. 3 shows a timing of an illustrative example execution using a cache and prefetch cache preload according to various embodiments. To better assist in explaining the FIG. 3 illustrative example execution 300, certain references to the example FIG. 1 architecture 10, and to the example web services search caching proxy 200 of FIG. 2, are included. These certain references to the example environments shown at FIGS. 1 and 2, however, and are not limiting as to the scope of the invention or of practices according to its embodiments.

Referring now to FIG. 3, and assuming the example operation being on a system according to FIG. 1 described above, the example 300 starts at 302 where a web services requester, e.g., the web services requestor 14, sends a web services request, e.g., SQⱼ, as described above, directed to the web services registry 12. Using one or more messaging schemes apparent to persons skilled in the relevant art in view of this disclosure, at 304 the request SQⱼ is received by the web services search caching proxy 18 of FIG. 1, and the caching proxy 18 performs a cache search, such as described in reference to FIG. 2, to identify between a HIT and a MISS. If the web services caching proxy 18 identifies a HIT, meaning that the request SQⱼ, has been previously searched and the results WR(SQj) are still available in the caching proxy, then at 306 the cache result, labeled for example as Cached(WR(SQⱼ)), is communicated back to the requestor 14 of FIG. 1.

With continuing reference to FIG. 3, if at 304 the cache search identifies a MISS then, at 308, the proxy search cache 18 forwards the request SQⱼ to the web services search prefetching proxy 20. The prefetching proxy 20 then, at 310, applies a precalculated likely next search rule E to SQⱼ to identify if any likely next search ESQⱼ₊₁ is generated. Illustrations of the rule E, calculation of E, and applications of E to a search request SQⱼ to identify ESQⱼ₊₁, if any, are described in greater detail in later sections. Referring to FIG. 3, after 310 identifies ESQⱼ₊₁, if any, the web services search prefetching proxy 20 executes a search 312A of the web services registry 12 using the immediate search request SQⱼ and, either concurrently or displaced in time relative to 312A, at 312B executes a prefetch search of the web registry using the likely next search request or set of requests ESQⱼ₊₁, if any.

Referring to FIG. 3, at 314 the web registry 12 communicates the search result WR(SQⱼ) and the prefetch search result WR(ESQⱼ₊₁), if any, back to the search prefetching proxy 20.

Next, at 316 the search prefetching proxy 20 may format the search result WR(SQⱼ) and the prefetch search result WR(ESQⱼ₊₁) into, for example, a list that associates the respective responses to their corresponding search request SQⱼ and likely next search request ESQⱼ₊₁. The 316 formatting may facilitate subsequent preloading of the search caching proxy 18 with the prefetch search result WR(ESQⱼ₊₁), and reporting of the search result WR(SQⱼ) back to the requestor 14. As will be apparent to persons skilled in the relevant arts, the particular formatting protocol at 316 will depend on the particular system implementation. The 316 formatting may, for example, form a list, arbitrarily labeled in this description as ResponseList(SQⱼ,ESQⱼ₊₁) reflecting a one-by-one wrapping into pairs of, for example, each search request object in SQⱼ with its corresponding object within the search response WR(SQⱼ) and, likewise, pairs of each search request object in ESQⱼ₊₁ with its corresponding object in the search response WR(ESQⱼ₊₁).

With continuing reference to FIG. 3, at 318 the web services search prefetching proxy 20 returns the formatted search result WR(SQⱼ) and prefetch search result WR(ESQⱼ₊₁), i.e., the response list ResponseList(SQⱼ,ESQⱼ₊₁), back to the web services search caching proxy 18. Next, at 320, the web services search caching proxy 18 separates the 318 communicated formatted search result WR(SQⱼ) and prefetch search result WR(ESQⱼ₊₁), updates the cache with WR(SQⱼ) and preloads the cache with WR(ESQⱼ₊₁) and, at 322, communicates the search request result WR(SQⱼ) back to the requestor 14. The operation 320 may, for example, parse the response list ResponseList(SQⱼ,ESQⱼ₊₁) to extract the above-identified example object pairs, store the objects represented by WR(SQⱼ) and WR(ESQ_{J+1}) in the cache storage, e.g., cache store unit 206, and store the objects or a hash of the objects, corresponding to the present search request SQⱼ and likely next search requests ESQⱼ₊₁ in a pointer table, such as the pointer table 202 of the FIG. 2 example 200, pointing, respectively, to the objects associated with the WR(SQⱼ) and WR(ESQ_{J+1}, in the cache storing unit 206.

Various example features and aspects of generating the prediction rule E for practicing the various embodiments will now be described.

In overview, according to various exemplary embodiments, the rule E for identifying the likely next web services request may be represented as, for example, a directed graph representing queries SQ as nodes, with directed edges connecting the nodes, each edge having a weight representing the conditional probability or likelihood of a search request SQ at the destination end of the edge being the next search request given that the node at the start end of the edge is the present search request, with a weight representing the probability or likelihood.

According to one aspect, in a directed graph representation of E a weight of an edge connecting a start node to a succeeding node may be calculated to represent a quantity of observed occurrences of the search request Sⱼ₊₁ represented by the succeeding node as immediately succeeding the search request Sⱼ represented by the start node. According to one aspect, as will be described in greater detail, when the construction of a directed graph representing E forms multiple nodes as succeeding a given node, by respective different edges, the edge with the highest weight may be a selection basis for the estimated next search request.

Example embodiments and aspects of generating a directed graph form of a likely next search request rule E are described in greater detail in sections below.

In overview, according to various exemplary embodiments, generation of the directed graph embodiment of E creates a new vertex, or node, when a web services request SQ is received for which there is not already a vertex or node in the directed graph. The generation process may store the previous received web services request to create an edge between its corresponding vertex and the node that was just created—preferably subject to qualifying the two successive received web services requests as having logical dependency, e.g., as originating from the same search session. The weight of an edge is, according to one aspect, incremented whenever a succession of two requests has already been captured in the graph by an edge.

One example test for determining logical dependency between successive search requests is based on the time lapse between the successive search requests. If the time lapse exceeds a given threshold, which is readily determined, the successive search requests are not likely logically related.

Further, according to one aspect, in a directed graph representation of a rule E, a threshold TH may be given such that, even though an edge connects nodes, if the weight of the edge does not exceed the threshold, the next search request to which the edge points will not qualify as a usable estimate of the next search node. As will be apparent to persons of ordinary skill in the art upon reading this disclosure, this threshold qualification aspect may be employed to lower incorrect generation of the next search request and, hence, valueless prefetches and preloadings of the cache.

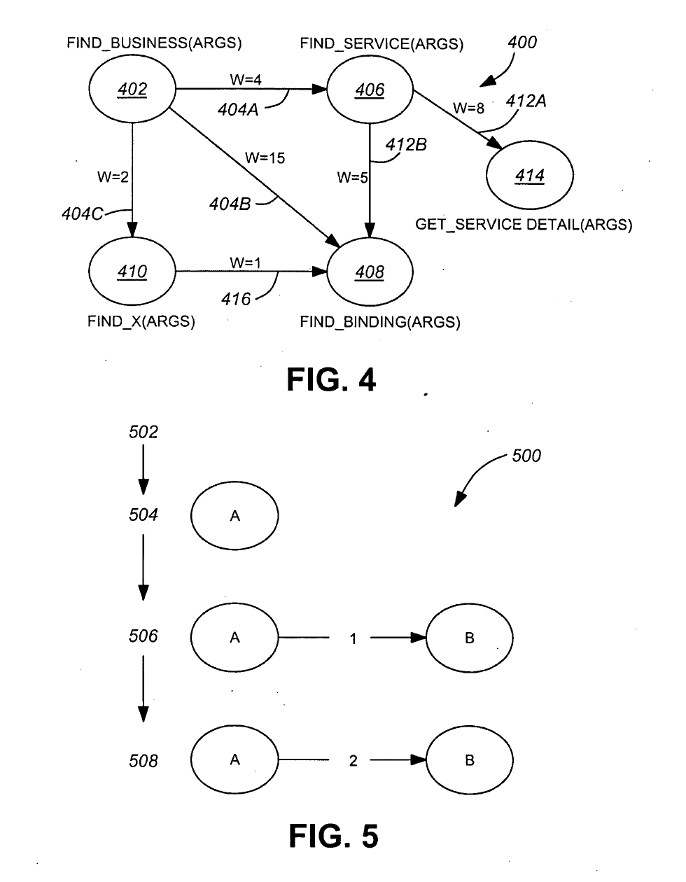

FIG. 4 shows a graphical representation of one example, hypothetically constructed, of a directed graph 400 representing one example E for identifying a likely next search request E. Turning to FIG. 4, the directed graph 400 includes a first node 402 corresponding to a request SQⱼ having a form of, as one illustrative arbitrary example, “find_business (args).” Three edges, 404A, 404B, and 404C extend from node 402, the edges having respective weights of, for arbitrary example, weight 404A=4, weight 404B=15 and weight 404C=1. In the example 400, edge 404A connects to node 406 which, relative to node 402, is a next search request SQⱼ₊₁, representing a search request having a form, as an arbitrary example, of “find_service(args).” Edge 404B likewise connects to node 406 that represents a next search request having a form, in the example, of “find_binding(args).” Edge 404C connects to node 410 that represents a next search request having an example form of: “find_X(args).”

With continuing reference to FIG. 4, the weight of edge 404A, Weight(404A)=4 means, in the graph 400 constructed as it appears, there were four (4) instances of the search request represented by node 406, i.e., “find_service (args),” being received within a given interval of, for example, T seconds after receiving the search request represented by node 402, i.e., “find_business (args).” The purpose and operation of the time duration T is to identify, with an acceptable accuracy, that the search request SQⱼ₊₁ is logically related to a preceding search request Sⱼ, as described in greater detail later.

Referring to FIG. 4, the weight of edge 404B, weight(404B)=fifteen (15) means, in this same example construction 400, that over approximately the same time history over which four (4) instances of edge 404A occurred, there were fifteen (15) instances of edge 404B, namely receiving the search request represented by node 408, i.e., “find_binding (args)” within T seconds after receiving the search request represented “find_business(args)” at node 402. Lastly, in the example 400, with respect to node 402, edge 404C having weight=two (2) means that, over approximately the same time history, there were two (2) instances of receiving the search request represented by node 408, i.e., “find_X(args),” within T seconds after receiving “find_business(args)” at node 402.

Referring to FIG. 4, all other depicted edges have weights representing the number of instances, over the same general time history, that a search request SQ represented by the destination node of an edge was received within time interval T after receiving the search request represented by the origin node of the edge. For example, edge 412A of weight=8 connects node 406 to node 414, representing eight (8) instances of receiving “get_ServiceDetail(args)” within time interval T of receiving “find_service(args).” Edge 412B of weight=five (5) connects node 406 to node 408, represents five (5) instances, over the same general time history, of receiving the search request “find_binding(args)” within the time interval T after receiving the search request “find_service(args).” Edge 416 of weight=one (1) represents one instance of receiving the search request “find_binding(args)” within the time interval T of receiving the search request “find_X(args).”

Application of an example rule E, as represented by a directed graph such as the FIG. 4 example 400 is described later in greater detail.

As will be apparent to persons of ordinary skill in the art upon reading this disclosure, the specific search requests SQ, as well as the statistics as to which search request follows another and, therefore, the particular nodes, edges, and the weights of the various edges, may have various correlations to the kinds of web services searched, the characteristics of the web service requesters, and various other factors. According to one aspect, therefore, a directed graph such as the example 400 of FIG. 4 may be generated and maintained for each of a plurality of N individual web service clients, with an index of, for example Eₙ, n=1 to N.

According to another aspect, a different rule E and associated directed graph may be generated for each of, for example, a plurality of N different topics of web services searched, e.g., the web services topic of consumers purchasing auto insurance, or trip planning, travel reservations, as well as various health services transactions. It will be apparent to persons skilled in the relevant arts, based on this disclosure, that these are not intended to be limitative and, instead, are only illustrative examples of web services topics for which different next search request rules E may provide benefit with respect to the accuracy rate of the selected next search request, e.g., ESQⱼ₊₁, being the next search request SQⱼ₊₁.

Further to this above-described aspect, other various implementations and arrangements will be apparent to persons skilled in the relevant arts based on this disclosure such as, for example, a plurality of web services topics and an identifier (not shown in the figures) being assigned to each, and a directed graph such as 400 constructed for each. Further to this aspect, association of a session searching a particular web services topic may include, as one illustrative example, an instantiating of the session retrieving a corresponding one or more of a plurality of N different rules Eₙ, n=1 to N.

With continuing reference to FIG. 4, an example execution of a likely next search rule E, as represented by the particular directed graph 400 and its particular nodes, edges and edge weights, is described, to further illustrate details of operations of the invention. The example assumes, for purposes of simplicity, that the only one next likely search result ESQⱼ₊₁ is identified. According to one example aspect, the one is identified by receiving a search request SQⱼ, identifying if a node exists in the graph, e.g., graph 400, for the search request and, if yes, identifying if an edge exits the node and, if yes, picking the largest weight of the edges leaving the node as ESQⱼ₊₁. According to another aspect, if a plurality of edges exit the node, pick all of the edges having a weight exceeding a given threshold, and identify all of these edges' respective destination nodes as next search requests ESQⱼ₊₁.

Continuing with an illustrative example that picks only the largest edge, the example assumes receipt of a search request SQⱼ having a value of: “find_business(args).” Referring now to the particular graph 400 of FIG. 4, there is a node representing “find_business(args),” which is node 402. If there were no node representing “find_business(args)” then no likely next search request would be identified but, as described in greater detail in sections hereinbelow, a node may be added. In the present example, though, a node 402 already exists. Further, over the history represented by the graph 400, the history being either of a particular user or a larger population of users searching, for example, the same topic of web services, three different search requests SQ have been recorded as following “find_business(args),” i.e., node 402. In the example graph 400, the three observed follow-on search requests SQ, relative to “find_business(args)” represented by node 402 are: “find_service(args)”, represented by node 406; “find_binding(args)”, represented by node 408; and “findX(args)”, represented by node 410. Edge 404B, though, has the greatest weight, namely weight=15 and, therefore, in this example, the most likely next search request is the node to which edge 404B points, namely node 408, representing “find_binding(args).” Therefore, applying the rule E represented by the example directed graph 400 to a received request SQj=“find_business(args),” the likely next search request, i.e., ESQⱼ₊₁, is “find_binding(args).”

In another example hypothetical, showing another operation of an example directed graph such as 400 of FIG. 4, it is assumed that a search request SQj=“find_service(args)” is received. Looking to FIG. 4, in the example graph 400 there are two (2) observed next search queries, which are: “get_serviceDetail(args)” represented by node 414, and “find_binding(args)”, represented by node 408. The edge 412A that connects to node 418 though, has the greatest weight, namely eight (8) and, therefore, the rule E generates the likely next search request ESQⱼ₊₁ as “get_serviceDetails(args).”

Still another hypothetical example SQ, showing another aspect, is that a threshold TH may be included in the rule E. To illustrate TH, an example TH=three (3) is arbitrarily picked. Further in this hypothetical, a search request of “find_X(args)” is received. Turning to FIG. 4, it is seen that node 410 shows that the search request of “find_X(args)” has been previously received. The graph 400 also shows, by edge 416 connecting node 410 and node 408 and its weight of one (1), that in one (1) instance the search request of “find_binding(args)” immediately succeeded “find_X(args),” within the T time duration. However, the weight of edge 416, namely one, is below the threshold TH=three. Therefore, in this illustrative example, the rule E does not identify the node 408 and its represented “find_binding(args)” as the likely next search request ESQⱼ₊₁.

As readily apparent to persons skilled in the relevant arts, based on this disclosure, the threshold TH may be set based on, for example, a statistical cost-benefit basis such as, for example, comparison of the probable benefit, which is the probability of the next search request ESQⱼ₊₁ being the next search request SQⱼ₊₁, multiplied by a value of the prefetching with SQⱼ₊₁ and preloading the cache with useful search results, against the probable cost, which is the probability of the next search request ESQⱼ₊₁ not being the next search request SQⱼ₊₁, multiplied by a cost of the prefetching with SQⱼ₊₁ and preloading the cache with not useful search results.

The above-described example operation identified the likely next search request ESQⱼ₊₁ as a single member set. This is only one example operation. The rule E, and the directed graph 400 may be applied to a received search request SQⱼ to generate a set ESQⱼ₊₁ having a plurality of members. The search prefetching proxy, such the proxy 20 of FIG. 1, may then access the web registry 12 to prefetch the web results for the each member of the set ESQⱼ₊₁. Generating of the plural member set ESQⱼ₊₁ may be performed as a breadth-first search on the graph 400. Two thresholds may, for example, be used to limit the size of the set ESQⱼ₊₁, such as, for example, the depth of the search, and the above-described weight of the edges TH.

As one illustrative example, referring to the FIG. 4 example directed graph 400, a pre-defined depth of two may be used, and a predetermined weight threshold of five may be used.

FIG. 5 graphically depicts on example 500 of generating a directed graph embodiment of a rule E for identifying a likely next search request ESQⱼ₊₁.

Referring to FIG. 5, at 502, a null graph is instantiated, having no nodes and no edges. Next, at 504, a first search request SQj=“MSG_A”, is received, and a corresponding node Node_A is created. Next, at 504 a new message, “MSG_B”, is received, less than T seconds after message “MSG_A” was received at 502. The time duration T represents a pre-set time threshold for determining whether received messages can be considered as belonging to the same sequence of search queries SQ or whether they are deemed independent. The value of T varies with respect to implementation and environment, and is readily determined by persons skilled in the relevant arts upon reading this disclosure. One illustrative example is training by sampling and statistical modeling of time differences between successive search queries from known requesters performing searches in known or controlled topics of web services.

With continuing reference to FIG. 5, in this particular example, at 504 a message, e.g., MSG_B is received within T of MSG_A and, therefore considered related to MSG_A, and therefore a new node, e.g., NODE_B is instantiated, with an edge, EDGE_A_B, having an initial weight=1. Next, at 506, search request MSG_B is received again, also in less than T seconds after the previous message, MSG_A. Since Node_A and Node_B already exist, the only change to the graph 500 at 506 is to increase in the weight of the EDGE_A_B to weight=2. Lastly, at 508, after an arbitrary time lapse exceeding T after receiving MSG_B, another MSG_A is received. Since the time lapse exceeded T, this instance of MSG_A is deemed independent from the message preceding it MSG_B and, therefore, no edge is created originating at Node_B and terminating at Node_A.

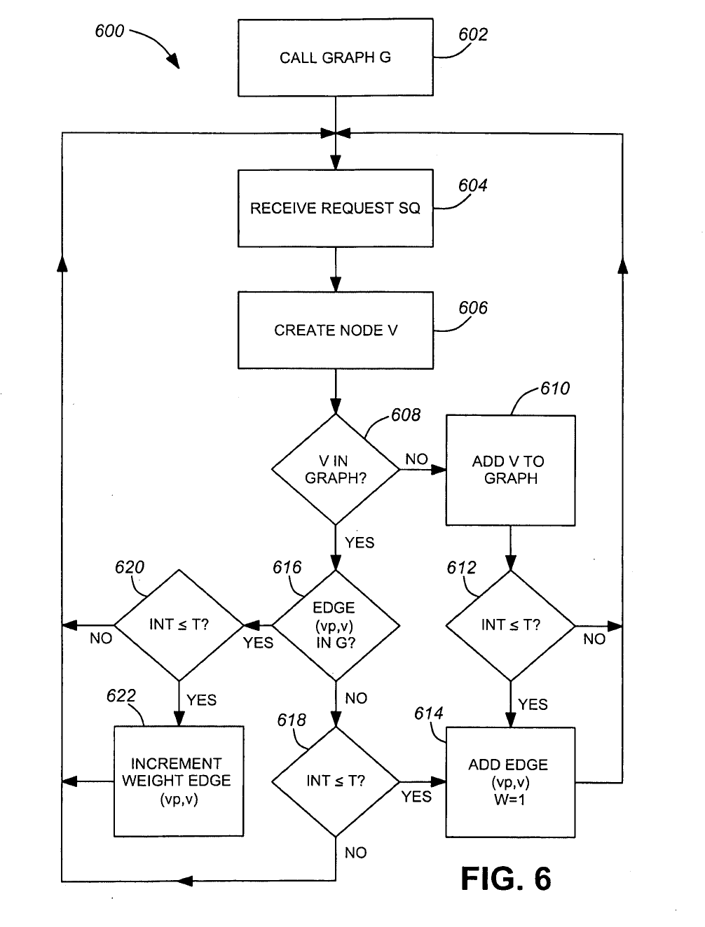

Many implementations, variations and alternatives to the FIG. 5 generating a directed graph for E, such as the example illustrated at FIGS. 4, will be apparent to persons skilled in the relevant arts based on this disclosure. For example, FIG. 6 shows a functional flow 600 for a pseudo-code representing one illustrative example of executable instructions for a data processing machine to generate a directed graph such as the FIG. 4 example 400.

Referring now to FIG. 6, at 602 a graph G is retrieved having an arbitrary number of nodes υ and an arbitrary number of weighted edges edge (υp, υ), where υp is the node representing the most recently received previous search request. Assuming that a search request corresponding to υp was received at time=0, then at 604 another search request, (e.g., SQj from requestor 14), is received and, in response, at 606 node υ is created. At 608 it is determined whether the node υ created at 606 exists in the graph G and, if NO, go to 610 add υ into G, and go to 612 to determine whether the time interval between receiving υ and υp is less than or equal to a threshold T. If YES, go to 614 and add directed edge (υp, υ) with weight one (1) into G and loop back to 604; if NO Ignore edge (υp, υ) and separate node υ and loop back to 604. If at 608 it is determined that υ already exists in G, then do not create a new node, and go to 616 to determine if the edge (υp, υ) already exists in G, meaning that v has previously succeeded υp.

With continuing reference to FIG. 4, and picking up with above-described example at 616, if 616 determines NO, the edge (υp, υ) does not already exist then identify, at 618, if the time interval between receiving υ and the previous υp is less than or equal to T. If the answer at 618 is YES, υ is identified as logically related to υp and, accordingly, go to 614 and add directed edge (υp, υ) with weight 1 into G. If the answer at 618 is NO Ignore edge (υp, υ). If the answer at 616 is YES, meaning edge (υp, υ) exists in G then, at 620 identify if the time interval is less than or equal to T. If the answer at 620 is YES then, at 622 increase by one the weight of directed edge (υp, υ). If the answer at 620 is NO then do nothing and loop back to 604 and wait for the next search request.

The cache can be used standalone and simply record responses to past requests. When a request is made for which the response has already been recorded in the cache, the cached response is used instead of accessing the registry. The closer the cache is placed to the client, the lower the latency will be. But the more clients it services, the more opportunities for caching will exist, and the number of hits would increase, possibly at the expense of cache memory usage and cache search performance (the increase of the size of the cache affects the time it takes to retrieve an item from it).

While certain embodiments and features of the invention have been illustrated and described herein, upon reading this disclosure many modifications, substitutions, changes, and equivalents will occur to those of ordinary skill in the art.

We hereby claim:

1. A method for a client querying a registry of web services, comprising:
providing a cache capable of connection to the client and to the registry;
receiving, at the cache, a web service registry request from the client;
identifying between a cache hit indicating a cache content associated with the web service registry request, and a cache miss indicating no content associated with the web service registry request;
in response to identifying a cache hit, communicating, the associated cache content to the client; and
in response to identifying a cache miss, applying a prediction rule to the web service registry request to generate one or more likely next web service registry request, searching the registry based on the web service registry and the likely next web service registry requests, updating the cache based on a result of the searching, and communicating a result of the searching to the client.

2. The method of claim 1 further including, in response to identifying a cache miss, updating the prediction rule based on the web service registry request.

3. The method of claim 2, wherein said receiving a web service registry request further includes detecting and storing a time of the receipt, and wherein said updating is further based on a comparing of the time of receipt of said web service request to the time of receipt of a previously received web services registry request.

4. The method of claim 1, wherein said prediction rule is based on a history of received web services registry requests.

5. The method of claim 4, further comprising calculating said prediction rule based on detecting time lapses between receiving successive different web service registry requests and, based on said detecting, associating particular successive different web service registry requests as logically related.

6. The method of claim 5, wherein said calculating includes assigning a connector weight between particular successive different web service registry requests, the connector weight connection value representing a quantity of occurrences of the particular different web service registry requests as succeeding one another within a given time lapse.

7. The method of claim 4, wherein said prediction rule is a directed graph rule having nodes representing previously received web services registry requests, and edges connecting pairs of the nodes, each edge having a weight representing a quantity of occurrences of receiving, in time succession, the web service registry requests represented by the nodes.

8. The method of claim 5, wherein said calculating includes forming a directed graph having nodes representing previously received web services registry requests, and edges connecting pairs of the nodes, and wherein said associating different web service registry requests as logically related assigns a corresponding weight to said edges.

9. The method of claim 7, wherein said applying said prediction rule searches said directed graph based on said received web services registry request to identify nodes representing said received web services registry request, and generates said likely next web services requests based on the edges connected to the identified nodes.

10. The method of claim 9, wherein further including providing a connection threshold, and wherein said applying said prediction rule includes identifying edges connected to each node identified as representing said received web services request, comparing the identified edges to said connection threshold, and generating said likely next web services request based on said comparing.

11. A web services registry system for a client to search a web services registry based on web service requests, comprising:
a caching proxy connected to the client, to store the web service requests and associated web service registry search results, to receive the web service requests, to search a cache to identify a hit or a miss based on the received web service request, and to communicate cached web service registry search results to the client; and
a prefetching proxy to receive web service registry requests, to apply a prediction rule to the received web service registry requests to generate likely next web service registry requests, to search the web registry based on the generated likely next web service requests, and to preload the caching proxy with the results of the search.

12. A web services registry system comprising:
a client to send web services registry requests;
a caching proxy connected to the client, to store web service requests and associated web service registry search results, to receive the web service requests, to search a cache to identify a hit or a miss based on the received web service request, to apply a prediction rule to the received web service registry requests to generate likely next web service registry requests, and to communicate cached web service registry search results to the client; and
a prefetching proxy to receive web service registry requests, to search the web registry based on the generated likely next web service requests, and to preload the caching proxy with the results of the search.

13. The web services registry system of claim 11, wherein said prediction rule is based on a history of received web services registry requests.

14. The web services registry system of claim 12, wherein said prediction rule is based on a history of received web services registry requests.

15. The web services registry system of claim 11, wherein said prefetching proxy is arranged to update the prediction rule based on receiving web service registry requests.

16. The web services registry system of claim 12, wherein said caching proxy is arranged to update the prediction rule, in response to detecting a miss, based on the received web service registry request.

17. The web services registry system of claim 11, wherein said prediction rule is a directed graph rule having nodes representing previously received web services registry requests, and edges connecting pairs of the nodes, each edge having a weight representing a quantity of occurrences of receiving, in time succession, the web service registry requests represented by the nodes.

18. The web services registry system of claim 12, wherein said prediction rule is a directed graph rule having nodes representing previously received web services registry requests, and edges connecting pairs of the nodes, each edge having a weight representing a quantity of occurrences of receiving, in time succession, the web service registry requests represented by the nodes.
